(19) United States
(12) Patent Application Publication
(10) Pub. No.: US 2011/0024513 A1
(43) Pub. Date: Feb. 3, 2011

(54) Diverter valve and heating system

(76) Inventor: Matthew Davidson, Worcester (GB)

Correspondence Address: IRA S. DORMAN, 330 ROBERTS STREET, SUITE 200, EAST HARTFORD, CT, 06108, US

(21) Appl. No.: 12/803,980

(22) Filed: Jul. 12, 2010

(30) Foreign Application Priority Data
Jul. 30, 2009 (GB) 0913208.5

(51) Int. Cl. G05D 23/13; F16K 11/20

(52) U.S. Cl. 236/12.1; 137/597

(57) ABSTRACT

A diverter valve comprises a valve body defining first (1), second (5) and third (9) inlets and first (3) and second (7) outlets. A passage between the first inlet and the first outlet and first (11) and second (13) interconnected valve members within the valve body, the valve members being jointly movable between first and second positions. In the first position, fluid is able to pass from the first inlet to the second outlet and from the third inlet to the first outlet, the passage between the first inlet and the first outlet being closed. In the second position, fluid is able to pass from the second inlet to the second outlet and along the passage from the first inlet to the first outlet.

This invention relates to a diverter valve and to a heating system employing such a valve.

### BACKGROUND TO THE INVENTION

New technology in water heating, such as heat pumps, can significantly improve the cost efficiency of heating buildings and/or providing hot water. Although installation into a new building is straightforward, fitting such technology to existing buildings is troublesome. In order to keep costs to a minimum it is generally necessary to retain an existing boiler and heating system and the new technology is required to provide a secondary source of relatively higher efficiency heating.

### OBJECT OF THE INVENTION

It is therefore an object of the present invention to provide a diverter valve which overcomes, or at least ameliorates, the above problems and a heating system incorporating such a diverter valve.

### SUMMARY OF THE INVENTION

According to one aspect of the present invention there is provided a diverter valve comprising:

a valve body defining first, second and third inlets and first and second outlets and a passage between the first inlet and the first outlet; and
first and second interconnected valve members within the valve body, the valve members being jointly movable between first and second positions,
wherein, in the first position, fluid is able to pass from the first inlet to the second outlet and from the third inlet to the first outlet, the passage between the first inlet and the first outlet being closed, and, in the second position, fluid is able to pass from the second inlet to the second outlet and along the passage from the first inlet to the first outlet.

The second inlet may be closed in the first position of the valve members.

The valve may include a passage between the first inlet and the second outlet, the passage being closed in the second position of the valve members.

The valve may include an injector in the second inlet.

The valve may include means, such as a coil spring, for biasing the valve members to the first position.

The valve members may be interconnected by a shaft.

One of the valve members may be positioned between the second inlet and the second outlet, the valve member being substantially conical, for example for sealing with the injector.

The valve members may be movable between the first and second positions by fluid pressure, for example solely by fluid pressure.

Alternatively or additionally, the valve may include actuating means for moving the valve members between the first and second positions. The actuating means may comprise a solenoid or a thermostatic device. Where the thermostatic device is provided, a by-pass may be provided in the second inlet to allow flow of (a relatively small amount of) fluid.

The valve members may be provided within a cartridge which may be, for example, cylindrical.

The valve members may be in the form of plate members which are movable in a linear manner, for example in a direction substantially perpendicular to the plane thereof. Alternatively, the valve members may be in the form of flap members which are pivotal about an edge region thereof.

A sealing member may be provided in a peripheral region of the valve members. The sealing member may be elastomeric material, for example rubber.

According to another aspect of the present invention there is provided a heating system including a diverter valve as hereinbefore defined, a primary source of heating fluid, a secondary source of heating fluid, and a fluid distribution circuit, the secondary source being connected to the first inlet and the first outlet, and the primary source being connected to the second inlet and the third inlet, and the fluid distribution system being connected to the second outlet and the third inlet.

The primary source of heating fluid may comprise a source of relatively high-temperature fluid and the secondary source of heating fluid may comprise a source of relatively low-temperature fluid.

The primary source of heating fluid may comprise a conventional heating boiler.

The secondary source of heating fluid may comprise a heat pump, such as an air source heat pump.

The fluid distribution circuit may comprise a hot water and/or a heating circuit.

For a better understanding of the present invention and to show more clearly how it may be carried into effect reference will now be made, by way of example, to the accompanying drawings in which:

### BRIEF DESCRIPTION OF THE DRAWINGS

FIG. 1 is a diagrammatic cross-sectional view of one embodiment of a diverter valve according to the present invention;

FIG. 2 is a diagrammatic cross-sectional view of another embodiment of a diverter valve according to the present invention provided with biasing means;

FIG. 3 is a diagrammatic cross-sectional view of a modification of the diverter valve shown in FIG. 2;

FIG. 4 is a diagrammatic cross-sectional view of another embodiment of a diverter valve according to the present invention provided with actuating means;

FIG. 5 is a diagrammatic cross-sectional view of an alternative modification of the diverter valve shown in FIG. 2;

FIG. 6 is a diagrammatic cross-sectional view of a further embodiment of a diverter valve according to the present invention, provided with flap valve members;

FIG. 7 is a diagrammatic cross-sectional view of another embodiment of a diverter valve according to the present invention provided with actuating means in the form of a liquid expansion device; and

FIG. 8 is a diagrammatic illustration of a heating system according to the present invention incorporating a diverter valve.

### DESCRIPTION OF PREFERRED EMBODIMENTS

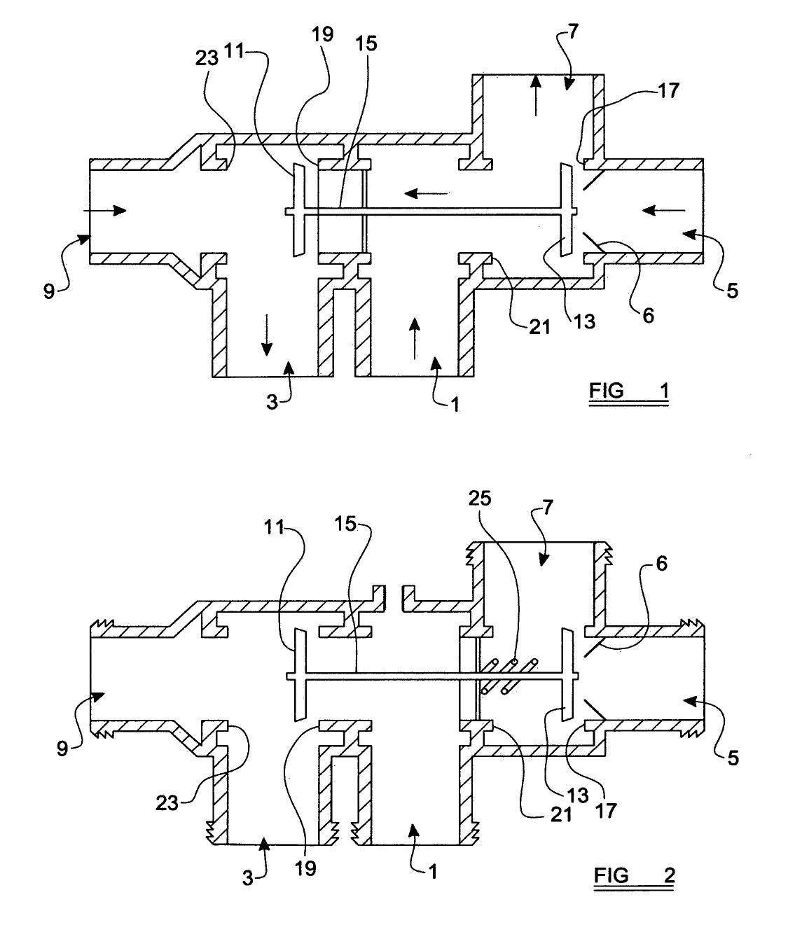

The diverter valve shown in FIG. 1 is adapted to control the directional movement of fluid for separately connecting primary and secondary heating fluid sources to a single output. The secondary heating fluid source is generally a relatively low-temperature source, such as a heat pump, especially an air source heat pump, and the primary heating fluid source is generally relatively high-temperature source, such as a boiler.

The valve has a body including a first inlet 1 for fluid, such as water, from a secondary heating fluid source, and an adjoining first outlet 3 for returning the (relatively low-temperature) fluid to its source, the inlet and outlet being interconnected by a flow path through the valve. The valve body also includes a second inlet 5 for fluid, such as water, from a primary heating fluid source, the inlet including an injector 6 for providing a relatively high flow rate of fluid exiting the injector.

The valve body has a second outlet 7 for connection to a fluid distribution circuit, for example a hot water system, such as a domestic hot water system, and a third inlet 9 for connection to returning fluid from the fluid distribution circuit. The outlet 7 is in fluid connection with both inlet 1 and inlet 5 and the inlet 9 is in fluid connection with the outlet 3.

Fluid flow through the valve is controlled by means of two valve members 11, 13 which are interconnected by a shaft 15, such as a rod, and which seal against alternate pairs of valve seats 17, 19 and 21, 23 as a result of movement of the shaft 15 and the valve members 11, 13 between a first position and a second position. The valve members are in the form of plates which are movable in a direction substantially perpendicular to the plates, that is in the axial direction of the shaft.

When only the secondary source is operating, the valve members are in their first position (moved to the right as shown in FIG. 1) with valve member 11 seated against valve seat 19 and valve member 13 seated against valve seat 17. In this configuration, (relatively low-temperature) fluid flows from inlet 1 to outlet 7 and through the fluid distribution circuit and returns through inlet 9 to outlet 3 to be further heated by the secondary source. In this way, when only the secondary source is operating, the fluid in the fluid distribution circuit is heated to a first (relatively low) temperature, but in a cost-effective way thereby providing preliminary heating for the overall system.

When only the primary source is operating, the valve members are in their second position (moved to the left as shown in FIG. 1) with the valve member 11 seated against valve seat 23 and valve member 13 seated against valve seat 21. In this configuration, (relatively high-temperature) fluid flows from the inlet to the outlet 7, while the inlet 9 is closed and returning fluid flows back to the primary source externally of the valve.

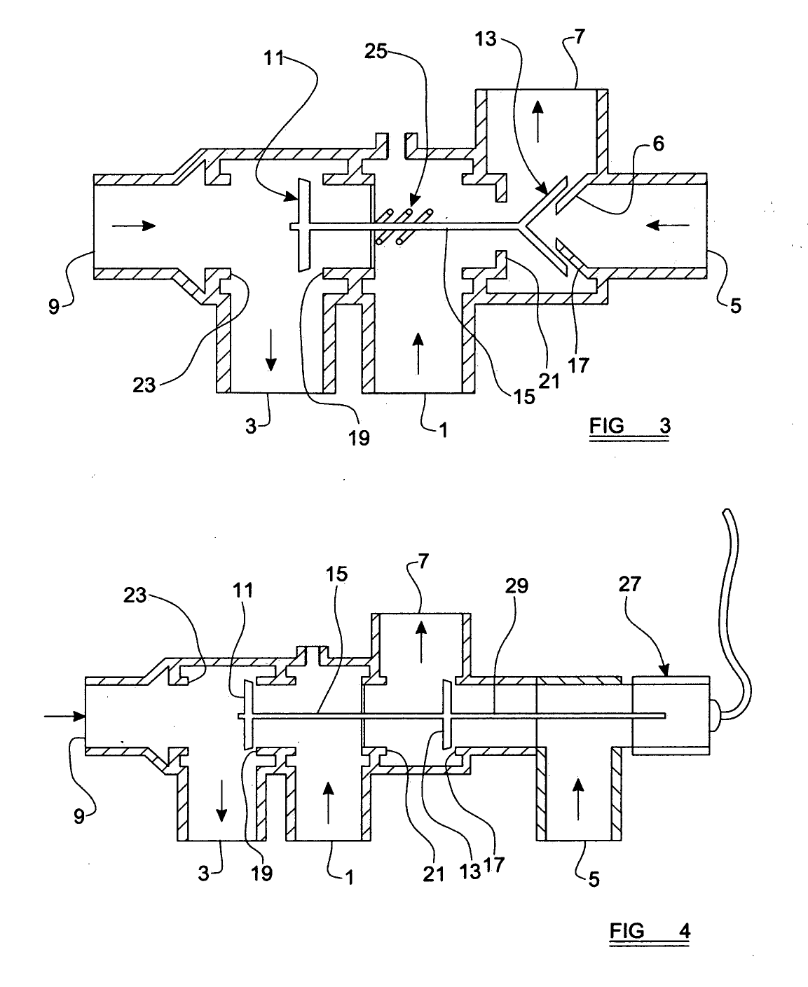

The valve members 11, 13 may be moved between their first and second positions in any convenient way, including fluid pressure or a separate actuator means. Where the fluid from the primary source is at a higher pressure than the fluid from the secondary source, the valve members may be biased to the first position, for example by a coil spring 25 as shown in FIG. 2. In this way, when only the secondary source is operating the valve members are in their first position and when the primary source replaces the secondary source, the higher fluid pressure causes the valve members 11, 13 to move to their second position until the primary source is turned off, when the valve members return to the first position.

FIG. 3 shows a modification of the valve shown in FIG. 2 in which the valve member 13 and valve seats 17, 21 have a modified configuration and the coil spring 25 is in an alternative location. As can be seen from the figure, the valve member 13 is substantially conical and seats against the injector 6.

FIG. 4 shows an actuator 27 in the form of a solenoid which is connected to the shaft 15 by an extension shaft 29 for moving the valve members 11, 13 between the first and second positions in response to a control signal, for example a control signal switching between the secondary and primary sources.

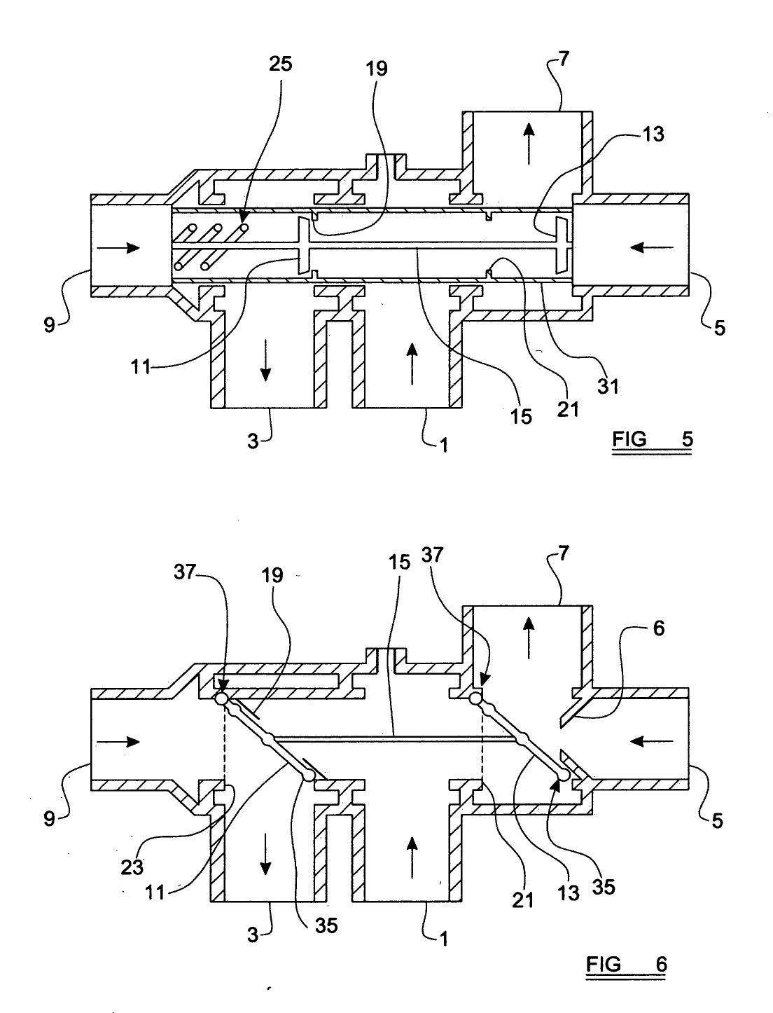

FIG. 5 shows an alternative modification of the valve shown in FIG. 2 in which the valve members 11, 13, shaft 15, valve seats 19, 21 and spring 25 are mounted within a cartridge 31 which is constructed, for example with apertures (not shown) to provide minimal resistance to fluid flow. It will be noted the valve seats 17 and 23 have been omitted because they are not essential to the operation of the valve.

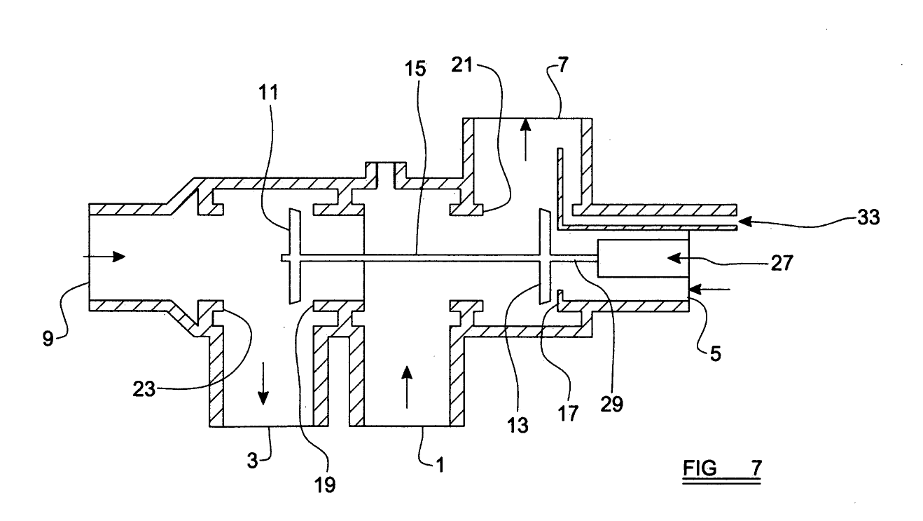

FIG. 6 shows a modified version of the diverter valve in which the valve members 11, 13 are in the form of flap valves interconnected by shaft 15 and rotatable about hinges 37 in an edge region thereof. In this embodiment the valve seats 17 and 19 are modified to be sealed by the valve members 11, 13 when the valve members are inclined. If required, the valve members may be provided in a peripheral region thereof with seals 35 of elastomeric material, such as rubber. The diverter valve is shown in its first position in which the low-temperature source is operating with water flowing from the secondary source, through the valve and out of the outlet 7, while returning water flows through the inlet 9 and through the outlet 3 back to the secondary heat source. Thus, the valve member 11 closes the path between the inlet 1 and outlet 3. In the second position of the diverter valve, as shown in dashed lines in FIG. 6, water passes through the inlet 5 and injector 6 from the primary source and through the outlet 7 because the valve member 13 is sealed against the valve seat 21, while returning water by-passes the inlet 9 because the valve member 11 is sealed against the valve seat 23.

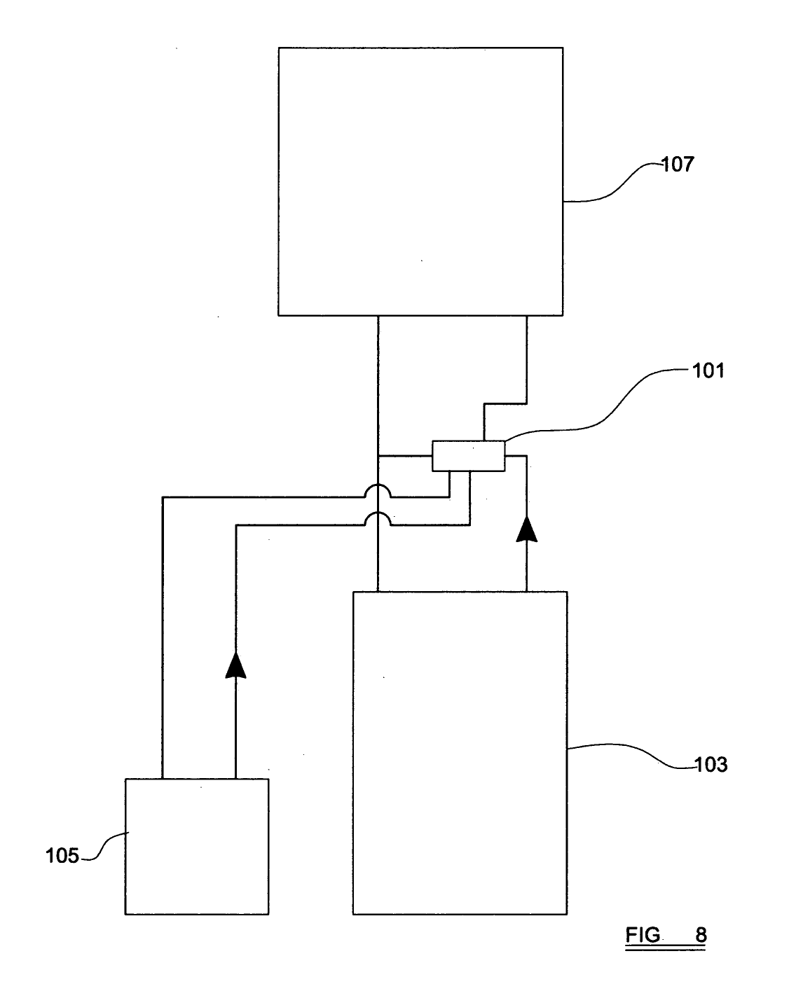

FIG. 7 shows an actuator 27 in the form of a liquid expansion device connected to the shaft 15 by an extension shaft 29 for moving the valve members 11, 13 between the first and second positions. Liquid in the liquid expansion device expands in response to relatively hotter water from the primary source to move the valve members from the first position to the second position. In order to ensure the relatively hotter water reaches the liquid expansion device 27 a by-pass channel 33 is provided around valve seat 17 to allow a small flow of water when the primary source is turned on and before the valve members move to their second position.

It should be noted that a liquid expansion device is only one form of thermostatic device that could be employed, including mechanical, electro-mechanical and electronic thermostatic devices which are well known to the skilled person.

FIG. 8 shows a heating system incorporating a diverter valve 101 such as a diverter valve as described and shown in relation to FIGS. 1 to 7. The heating system includes a primary source, for example of relatively high-temperature fluid, in the form of a boiler 103, such as a gas- or oil-fired boiler, a secondary source, for example of relatively low-temperature fluid, in the form of a heat pump 105, such as an air source heat pump, and a fluid distribution circuit in the form of a conventional heating circuit 107 including, for example a hot water circuit and/or a heating circuit which may include conventional radiators. The boiler 103 and heating circuit 107 are commonly found in domestic premises, but are difficult to link to heat pump 105 in the absence of diverter valve 101, especially when a buffer tank is not present as is the case with, for example, many heating systems incorporating condensing boilers. The boiler 103 is connected to inlet 5 of the valve and to inlet 9, although fluid does not flow into the inlet 9 when the boiler is in use. The heat pump is connected to the inlet 1 of the valve and to the outlet 3. The heating circuit is connected to the outlet 7 and to the inlet 9, although fluid does not flow into the inlet 9 when the boiler is in use.

In use of the heating system according to the present invention, the secondary source provides a heating system, for example a pre-heating system, which operates when the primary source is not operating. Consequently, the primary source does not need to heat the water from cold, but only, for example, from an intermediate temperature provided by the secondary source, thereby saving fuel and reducing heating and/or hot water costs.

I claim:

1. A diverter valve comprising:
a valve body defining first, second and third inlets and first and second outlets and a passage between the first inlet and the first outlet; and
first and second interconnected valve members within the valve body, the valve members being jointly movable between first and second positions,
wherein, in the first position, fluid is able to pass from the first inlet to the second outlet and from the third inlet to the first outlet, the passage between the first inlet and the first outlet being closed and, in the second position, fluid is able to pass from the second inlet to the second outlet and along the passage from the first inlet to the first outlet.

2. A diverter valve as claimed in claim 1, wherein the second inlet is closed in the first position of the valve members.

3. A diverter valve as claimed in claim 1, wherein the valve includes a passage between the first inlet and the second outlet, the passage being closed in the second position of the valve members.

4. A diverter valve as claimed in claim 1, wherein the valve includes an injector in the second inlet.

5. A diverter valve as claimed in claim 1, wherein the valve includes means for biasing the valve members to the first position.

6. A diverter valve as claimed in claim 1, wherein the valve members are interconnected by a shaft.

7. A diverter valve as claimed in claim 1, wherein one of the valve members is positioned between the second inlet and the second outlet.

8. A diverter valve as claimed in claim 7, wherein the valve member positioned between the second inlet and the second outlet is substantially conical.

9. A diverter valve as claimed in claim 1, wherein the valve members are movable between the first and second positions solely by fluid pressure.

10. A diverter valve as claimed in claim 1 and including actuating means for moving the valve members between the first and second positions.

11. A diverter valve as claimed in claim 10, wherein the actuating means comprises a liquid expansion device, a by-pass being provided in the second inlet to allow flow of fluid therethrough.

12. A diverter valve as claimed in claim 1, wherein the valve members are provided within a cartridge.

13. A diverter valve as claimed in claim 1, wherein the valve members are in the form of plate members which are movable in a linear manner.

14. A diverter valve as claimed in claim 13, wherein the plate members are movable in a direction substantially perpendicular to the plane thereof.

15. A diverter valve as claimed in claims 1, wherein the valve members are in the form of flap members which are pivotal about an edge region thereof.

16. A diverter valve as claimed in claim 1, wherein a sealing member is provided in a peripheral region of the valve members.

17. A heating system including a diverter valve as claimed in claim 1, a primary source of heating fluid, a secondary source of heating fluid, and a fluid distribution circuit, the secondary source being connected to the first inlet and the first outlet, and the primary source being connected to the second inlet and the third inlet, and the fluid distribution system being connected to the second outlet and the third inlet.

18. A heating system as claimed in claim 17, wherein the primary source of heating fluid comprises a source of relatively high-temperature fluid and the secondary source of heating fluid comprises a source of relatively low-temperature fluid.

19. A heating system as claimed in claim 18, wherein the primary source of heating fluid comprises a conventional heating boiler.

20. A heating system as claimed in claim 18, wherein the secondary source of heating fluid comprises an air source heat pump.
